(19) United States
(12) Patent Application Publication
(10) Pub. No.: US 2023/0259951 A1
(43) Pub. Date: Aug. 17, 2023

(54) WARRANTY PROCESSING SYSTEM FOR ROLL-OUT CARTS

(71) Applicant: Rehrig Pacific Company, Los Angeles, CA (US)

(72) Inventors: Vance Asher Weintraub, Chicago, IL (US); Robert Lee Martin, JR., Lucas, TX (US)

(21) Appl. No.: 18/109,204

(22) Filed: Feb. 13, 2023

Related U.S. Application Data
(60) Provisional application No. 63/309,077, filed on Feb. 11, 2022.

(51) Int. Cl. G06Q 30/012; G06V 10/70

(52) U.S. Cl. CPC G06Q 30/012; G06V 10/70

(57) ABSTRACT

A roll-out cart warranty processing system includes a mobile device app and a server. The mobile device app prompts a resident to take at least one image of the roll-out cart, particularly any damaged portion(s) of the roll-out cart. The mobile device app then uploads the at least one image to a server. The server analyzes the at least one image to determine whether the roll-out cart is covered by warranty. The server also analyzes the at least one image to determine whether any identifiable damage would be covered by warranty.

### BACKGROUND

Residential roll-out carts, such as are used for residential trash, recycling, or yard waste are often maintained and repaired by a third party. For example, the supplier of the roll-out carts may provide a warranty through the municipality in which they are supplied. Determining whether a particular repair is covered by the warranty can be difficult and time-consuming, both for the resident and for the third party. For example, the damage may be obviously caused by abuse or the resident may be using a container different from (or in addition to) that which was provided by the supplier.

### SUMMARY

A roll-out cart warranty processing system includes a mobile device app and a server. The mobile device app prompts a resident to take at least one image of the roll-out cart, particularly any damaged portion(s) of the roll-out cart. The mobile device app then uploads the at least one image to a server. The server analyzes the at least one image to determine whether the roll-out cart is covered by warranty. The server also analyzes the at least one image to determine whether any identifiable damage would be covered by warranty.

### BRIEF DESCRIPTION OF THE DRAWINGS

FIG. 1 shows a user using an app on a mobile device to make a warranty claim on a roll-out cart.

FIG. 2 is a schematic of the mobile device of FIG. 1.

FIG. 3 shows a login screen for an app on the mobile device.

FIG. 4 shows a menu on the app on the mobile device giving the user the ability to choose warranty claims.

FIG. 5 shows a screen on the app on the mobile device that directs and assists the user to take a photo of the damage to the roll-out cart.

FIG. 6 shows a damage detected confirmation on the app on the mobile device.

FIG. 7 shows a barcode scanning screen on the app on the mobile device.

FIG. 8 shows a warranty confirmation screen on the app on the mobile device.

FIG. 9 shows a claim confirmation and estimate screen on the app on the mobile device.

FIG. 10 shows a work order creation screen on the app on the mobile device.

### DETAILED DESCRIPTION

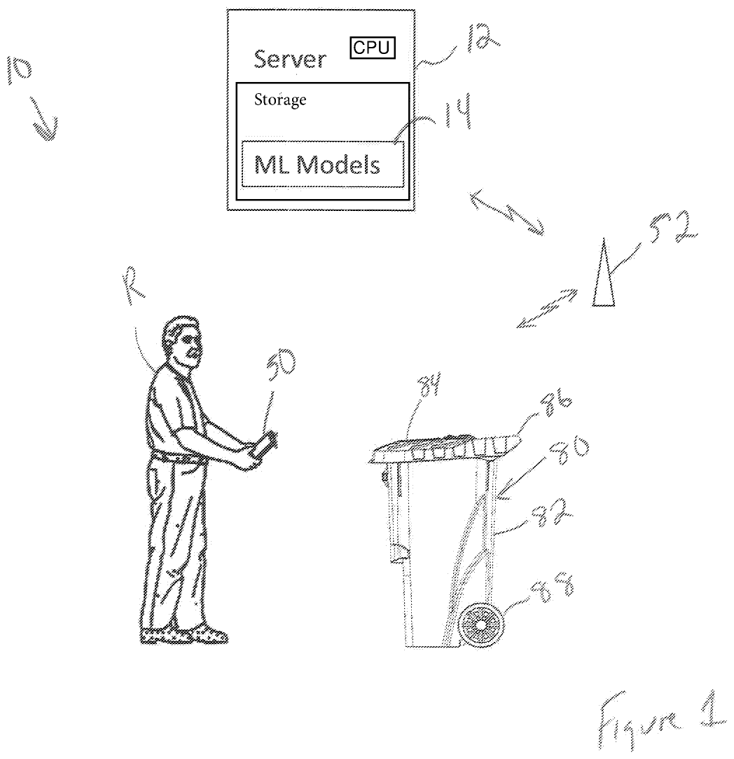

A warranty processing system 10 according to one embodiment of the present invention is shown in FIG. 1. The warranty processing system 10 is shown and described as particularly adapted for processing warranty repairs for waste collection containers, such as roll-out carts 80, such as may be used for residential trash, recycling, or yard waste.

The roll-out carts 80 may have a molded plastic container body 82 with a lid 84 hingeably connected to a handle 86 of the container body 82. A pair of wheels 88 may be mounted to a rear portion of the container body 82. In a given locality, residents, such as resident R shown in FIG. 1, may be provided roll-out carts 80 for which a supplier may have maintenance and repair responsibility.

A server 12 could be a cloud server including a cluster of computers including at least one processor 16 (and more likely multiple processors) and electronic storage 18 storing instructions which when executed by the processors perform the steps described herein. The electronic storage 18 also stores the data and machine learning models 14 as described herein.

The server 12 stores one or more machine learning models 14 trained with numerous images of roll-out carts 80 of the type available to the residents from the supplier (i.e. more than one size or style may be available). Some of these images are of the entire roll-out carts 80 at various angles and some of these images are at a variety of angles of specific areas on the roll-out carts 80, e.g. close-ups of the wheels 88, close-ups of the lid 84, close-ups of the hinge and handle 86 area, etc. Some of the images would be of a roll-out cart 80 (or portion thereof) that is intact and in working condition and some of the images would be of a roll-out cart 80 (or portion thereof) that is broken, worn, has a missing part, etc. Some of the images may be of a roll-out cart 80 (or portion thereof) with a condition that indicates abuse or misuse. Some of the images may be of a roll-out cart 80 (or portion thereof) with a condition that indicates acceptable wear and tear (i.e. no repair necessary). Some of the images may be of a roll-out cart 80 (or portion thereof) with a condition that indicates damage or wear that renders the roll-out carts 80 at least partially inoperable but is still not covered by warranty. All of the above-described images are labeled accordingly to train the machine learning models 14.

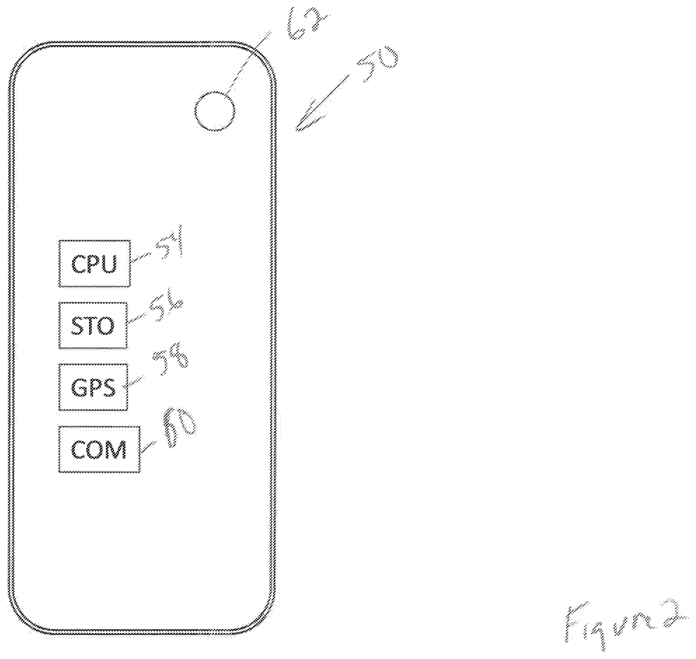

FIG. 2 is a schematic of one example of a mobile device that could be used as the mobile device 50 of FIG. 1. As is known, the mobile device 50 includes at least one processor 54 and electronic storage storing data and instructions, including the app, which when executed by the least one processor 54 performs the functions described herein. The mobile device 50 may also include a GPS receiver 58 and at least one communication circuit 60 (e.g. voice, cell data, Wi-Fi, Bluetooth, NFC, etc). The mobile device 50 could be a smartphone such as an iPhone or Android.

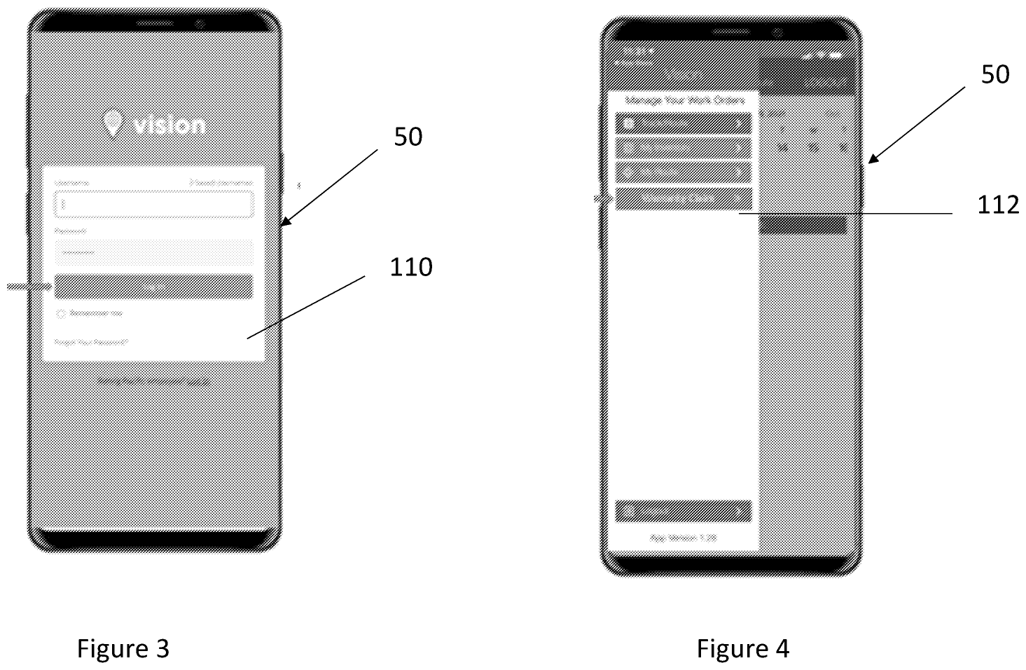

If resident R has a roll-out cart 80 for which the resident would like to obtain a repair or make a warranty claim, the resident R installs a dedicated app on their mobile device 50 (e.g. smart phone or tablet). Referring also to FIG. 3, the app on the mobile device 50 displays a login screen 110 in which the user can log into an account on the server 12 associated with the user, the user's address, and the user's roll-out cart 80.

Referring to FIG. 4, the app on the mobile device 50 then displays a menu 112 giving the user the ability to choose warranty claims.

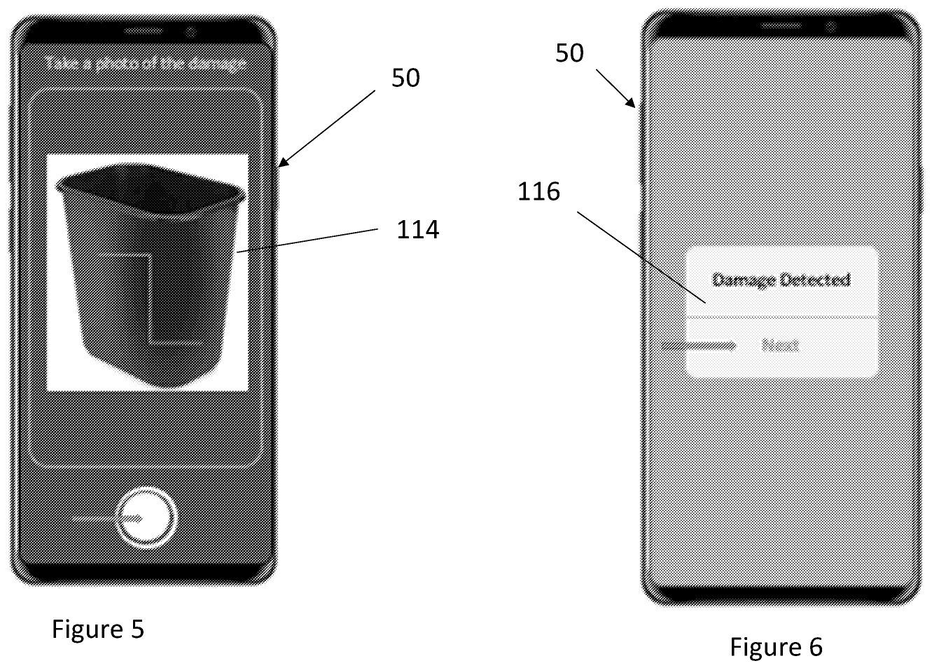

Referring to FIG. 5, the app then directs and assists the user to take a photo 114 of the damage using the mobile device 50. The app directs the resident R to take one or more images of the roll-out cart 80 or a relevant portion thereof (e.g. wheels 88, lid 84, handle 86, or whatever portion is damaged or in need of maintenance, etc) in the app. The photo(s) are uploaded by the app using the mobile device 50 to the server 12 via the internet 52, such as via a cell tower or wifi, etc.

The server 12 receives the photo(s) and performs an analysis based upon the one or more machine learning models 14. Based upon this analysis, the server 12 determines whether it can detect the damage to the roll-out cart 80. If so, a damage detected confirmation 116 is displayed on the mobile device 50 in the app, as shown in FIG. 6.

Based upon this analysis, the server 12 may:

a. determine whether the roll-out cart 80 was provided by the supplier and is covered by warranty or the roll-out cart 80 was not provided by supplier and is not covered by the warranty;

b. determine whether the damage identified by the one or more machine learning models 14 is covered by the warranty or the damage is not covered by warranty (e.g. obviously the result of abuse);

c. confirm and categorize the damage claim (e.g. wheels 88, lid 84, container body 82, handle 86, warrantied, not warranted, etc).

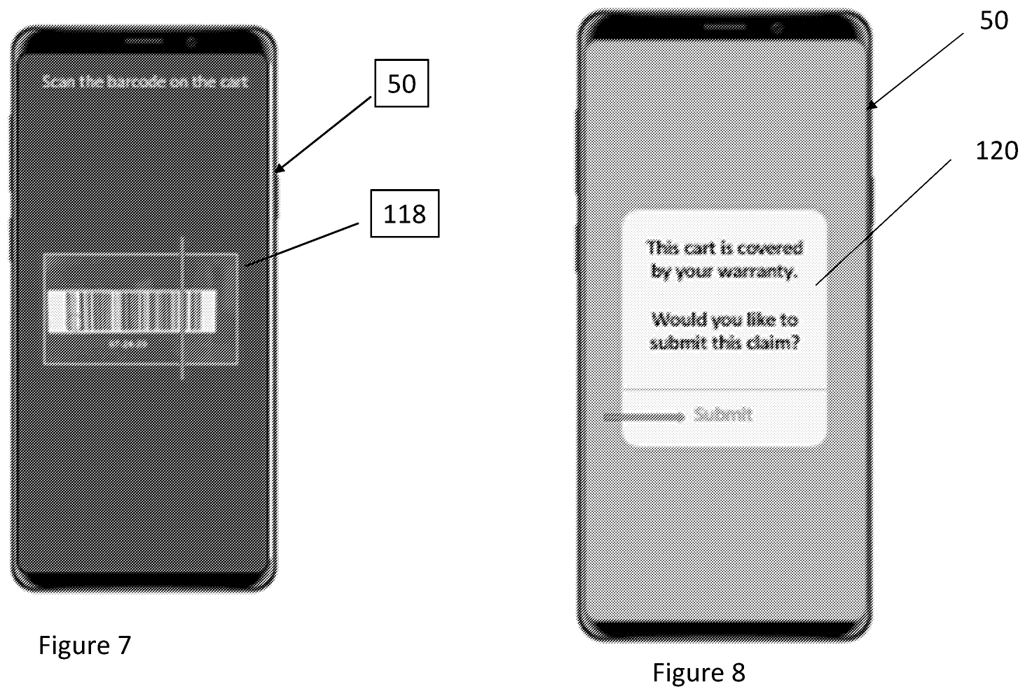

Referring to FIG. 7, if the roll-out cart 80 is confirmed to have been supplied by supplier and damage is covered by warranty the app in the mobile device 50 may optionally then direct the resident R to scan the barcode 118 on the roll-out cart 80 to identify the specific roll-out cart 80. The server 12 then confirms whether the cart 80 was supplied by supplier based upon the barcode 118 and whether the roll-out cart 80 is covered by warranty and determines whether the damage claim was already processed and refunded under a previous warranty claim. Alternatively, the resident R may be directed to read an RFID tag with the mobile device 50.

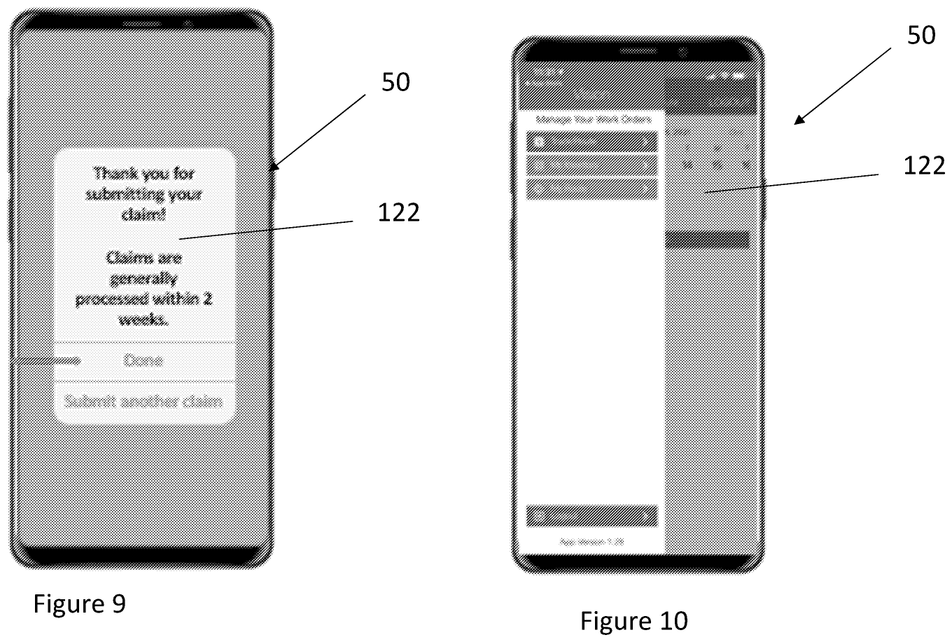

Referring to FIG. 8, the server 12 then indicates to the resident R (via the screen 120 on mobile device 50) whether the claim is covered by warranty (or not) and asks the resident R if the resident R wishes to submit the claim (the request for repair). The server 12 receives the request for repair and responds to the resident R on the screen 122 of FIG. 9 approximately how long the claim will take to process.

As shown in FIG. 10, the server 12 creates a work order to initiate the retrieval, repair and return of the roll-out cart 80.

Although described with respect to roll-out carts 80, the system 10 could be used with other items, such as toys, furniture, electronics, etc, by appropriate training of the one or more machine learning models 14.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric identifiers on method steps are for reference in dependent claims and do not signify a required sequence unless explicitly stated in the claims.

What is claimed is:

1. A method for processing a warranty claim on a waste collection container including:
a) receiving on at least one computer a request for a repair of a waste collection container;
b) receiving on the at least one computer at least one photo of the waste collection container; and
c) the at least one computer analyzing the at least one photo to determine whether the waste collection container is covered by a warranty.

2. The method of claim 1 wherein the at least one computer uses at least machine learning model to analyze the at least one photo in step c).

3. The method of claim 2 wherein the waste collection container is a roll-out cart.

4. The method of claim 2 wherein the at least one machine learning model has been trained with images of waste collection containers.

5. The method of claim 4 wherein the at least one machine learning model has been trained with images of damaged waste collection containers.

6. The method of claim 5 wherein the at least one machine learning model has been trained with images of damaged waste collection containers with damage that would be covered by the warranty.

7. The method of claim 6 wherein the at least one machine learning model has been trained with images of damaged waste collection containers with damage that would not be covered by the warranty.

8. The method of claim 7 wherein step a) includes receiving the request from a mobile device.

9. The method of claim 8 wherein step b) includes receiving the at least one photo from the mobile device.

10. The method of claim 9 wherein the waste collection container is a roll-out cart and wherein the at least one machine learning model has been trained with images of damaged roll-out carts.

11. The method of claim 7 further including sending an instruction to scan a barcode or RFID tag on the waste collection container and determining whether the waste collection container is covered by warranty based upon the scanned barcode or RFID tag.

12. A computing system for processing repair requests for waste collection containers including:
at least one processor; and
at least one non-transitory computer-readable media storing:
instructions that, when executed by the at least one processor, cause the computer system to perform the following operations:
a) receiving a request for a repair of a waste collection container;
b) receiving at least one image of the waste collection container; and
c) inferring a damage type of the waste collection container based upon the at least one image using at least one machine learning model.

13. The computing system of claim 12 wherein the at least one non-transitory computer-readable media further stores the at least one machine learning model.

14. The computing system of claim 13 wherein the at least one machine learning model is trained with images of waste collection containers, including damaged waste collection containers.

15. The computing system of claim 14 wherein the waste collection container is a roll-out cart.

16. The computing system of claim 15 wherein the at least one machine learning model has been trained with images of damaged waste collection containers with damage that would be covered by a warranty.

17. The computing system of claim 16 wherein the at least one machine learning model has been trained with images of damaged waste collection containers with damage that would not be covered by the warranty.

18. The computing system of claim 17 wherein the operations further include:
sending an instruction to scan a barcode or RFID tag on the waste collection container and determining whether the waste collection container is covered by warranty based upon the scanned barcode or RFID tag.
